(19) United States
(12) Patent Application Publication
(10) Pub. No.: US 2004/0175323 A1
(43) Pub. Date: Sep. 9, 2004

(54) Process and apparatus for preparing hydrogen chloride

(76) Inventors: Marcus Franz, Schwabmunchen (DE); Jurgen Kunzel, Thierhaupten (DE)

Correspondence Address: LERNER AND GREENBERG, P.A., POST OFFICE BOX 2480, HOLLYWOOD, FL, 33022-2480, US

(21) Appl. No.: 10/794,130

(22) Filed: Mar. 5, 2004

(30) Foreign Application Priority Data
Mar. 5, 2003 (DE) 103 09 799.6

(51) Int. Cl. C01B 7/03

(52) U.S. Cl. 423/486; 422/188; 422/196

(57) ABSTRACT

A process for preparing hydrogen chloride includes reacting chlorine with water vapor in an endothermic reaction with heat being supplied in a first process step to give a mixture of hydrogen chloride and oxygen. Then in a second process step, chlorine that has not been reacted in the first process step is converted into hydrogen chloride in an exothermic reaction by the addition of a reducing agent and oxygen formed in the first process step is bound by the reducing agent. An apparatus has first and second reactors for carrying out the process.

### BACKGROUND OF THE INVENTION

### FIELD OF THE INVENTION

The invention relates to a process for preparing hydrogen chloride which is not tied to the availability of hydrogen, and an apparatus for this process.

High-purity hydrochloric acid is produced according to the prior art in laminar burners by combustion of the elements chlorine and hydrogen and subsequent absorption of the hydrogen chloride obtained in this way in water. Hydrogen is introduced in excess in order to minimize the proportion of free chlorine in the product. In this way, the equilibrium in equation (1) is shifted to the product side.

Cl₂+(1+x)H₂→2HCl+xH₂ (1)

Since hydrogen and chlorine are in the most favorable case obtained in stoichiometric amount from electrolysis processes (chloralkali electrolysis), it is either necessary to consume excess chlorine in another way or to supply the hydrogen excess required for the process according to equation (1) from another process. If the chlorine gas for the synthesis of hydrogen chloride is obtained from a melt electrolysis as in, for example, the production of magnesium, the total amount of hydrogen has to be supplied by a hydrogen production plant, e.g. by reformation of natural gas.

The necessity of producing additional hydrogen can be circumvented if chlorine is reacted directly with natural gas and air:

xCl₂+yCH₄+_{Z}O₂+3.76_{Z}N₂→aHCl+bCO₂+cCO+dH₂O+eH₂+fN₂+eCl₂ (2)

In the process according to equation (2), hydrogen chloride (HCl, a≦2 x), carbon dioxide (CO₂) and water vapor (H₂O) are formed as main products. By-products obtained are carbon monoxide, hydrogen, oxides of nitrogen (NOₓ) and chlorinated hydrocarbons (CHCs) and also unreacted free chlorine. In this process, the nitrogen introduced with the combustion air passes through all parts of the plant, which therefore have to be made correspondingly larger. Because of the adiabatic combustion temperature for the process according to equation (2) is about 1950° C. and therefore too high for industrial applications, either additional water vapor is injected into the combustion chamber in which the reaction occurs or cooled product gas is recirculated into it. These measures allow, as described in Published, Non-Prosecuted German Patent Application DE 199 39 951 A, a product free of chlorine and CHCs to be produced, for example, in a pore burner. The injection of steam shifts the equation (2) to the starting material side as a result of the introduction of water vapor. Apart from cooling the combustion reaction, water vapor takes part in the combustion process due to its reaction with free chlorine:

Cl₂+H₂O→2HCl+0.5O₂ (3)

This process according to equation (3) that proceeds as a parallel reaction to the reduction of chlorine according to equation (2) corresponds to the reversal of the Deacon process for preparing chlorine from hydrogen chloride.

Carbon monoxide formed in the process according to equation (2) is oxidized to carbon dioxide in the presence of water vapor as a result of the homogeneous water gas reaction, and hydrogen is liberated at the same time:

CO+H₂O→H₂+CO₂ (4)

The hydrogen liberated in the process according to equation (4) can in parallel to the processes (2) and (3) contribute to the binding of free chlorine.

German Patent DE 38 11 860 C2 describes a process for preparing hydrogen chloride by combustion of chlorine-containing organic compounds, for example tetrachloromethane CCl₄, with natural gas and air, which produces a still chlorine-containing intermediate in a first stage in which an excess of air is present. German Patent DE 38 11 860 C2 indicates the following reaction equation, which is obviously stoichiometrically incorrect:

CCl₄+H₂O+O₂→CO₂+HCl+Cl₂+O₂ (5)

for this process. If the chlorine-containing compound is not sufficiently combustible, additional fuel has to be introduced.

However, it can be shown by thermodynamic calculations that the combustion temperature drops below 900° C. when the oxygen necessary for the reaction according to equation (5) is introduced in the form of air. Support firing, e.g. using natural gas, thus becomes indispensable in order to start and maintain a combustion reaction.

In the second stage of the process of German Patent DE 38 11 860 C2, the offgases from the process (5) are treated with an excess of reducing agent (CO and/or H₂, or gas obtained by combustion of a conventional fuel, e.g. natural gas, under reducing conditions), so that virtually complete removal of the oxygen from the offgas and reaction of the chlorine to hydrogen chloride is ensured. In German Patent DE 38 11 860 C2, this process is described by the following reaction equation, which is obviously stoichiometrically incorrect:

Cl₂+O₂+CO+H₂→CO₂+HCl+H₂O (6)

The process described in German Patent DE 38 11 860 C2 is economically disadvantageous because of its high consumption of fuel and reducing agent.

Published, Non-Prosecuted German Patent Application DE 122 82 32 describes a process for converting CHC wastes into hydrochloric acid and an offgas which is free of soot and chlorine. The process is based on the chlorine-reducing action of water or steam. CHCs having a chlorine content of not more than 75% are burnt together with steam, water and air at temperatures of from 950 to 1250° C. It was found that without the introduction of steam and water, the chlorine content of the product gas is considerably higher than when water is added. Preference is given to using a weight of water or/and water vapor that is twice the weight of chlorine present in the hydrocarbons to be burnt. The combustion air, too, has to be added in excess so that the formation of soot is ruled out. The combustion furnace has to be preheated, so that additional fuel, for example a fuel gas, is required for this process, too.

European Patent EP 0 362 666 B1 describes a process by which a CHC— and chlorine-free hydrochloric acid can be prepared from tailgases from chlorination reactions in a single-stage combustion reaction at from 800 to 1600° C. using oxygen or air and a fuel gas, for example hydrogen or methane, under reduced conditions. The concentration of CHCs which can be adsorbed on activated carbon in this hydrochloric acid is less than 1 g/l. A significant feature of this process is that excess hydrogen is present in the offgas in a proportion by volume of from 2 to 15% in order to avoid chlorine break through.

A characteristic of the process as described above is the use of oxygen, which for economic reasons is introduced not in pure form but in the form of air, as oxidant. However, this mode of operation has disadvantages:

a). The nitrogen introduced by the air makes the downstream absorption of the hydrogen chlorine more difficult.

b). In the process corresponding to equation (2), after-combustion of the tailgas remaining after absorption of the hydrogen chloride is absolutely necessary because of the CHC and carbon monoxide content. To achieve this, the entire cooled tailgas stream that has only a low calorific value has to be reheated by use of natural gas or other hydrocarbons with an excess of air.

c). There is a risk of the undesirable formation of oxides of nitrogen (NOₓ).

The reversal of the known Deacon reaction for obtaining chlorine from hydrogen chloride using air as oxidant

2HCl+0.5O₂→Cl₂+H₂O H_{R}=−57.42 kJ (3*)

makes it possible to prepare hydrogen chloride in accordance with equation (3) independently of the availability of hydrogen. The kinetics of this process have already been examined (see the reference by A. K. Nanda and D. L. Ulrichson, titled “The Kinetics of the Reverse Deacon Reaction”, Int. J. Hydrogen Energy, Vol. 13, No 2, pp. 67-76, 1988). The degree to which the chlorine is converted depends significantly on the parameters temperature and water vapor content. At temperatures of from about 500 to 700° C. and varying proportions of water vapor and chlorine in the feed gas, a chlorine conversion of at most 45% was achieved.

### SUMMARY OF THE INVENTION

It is accordingly an object of the invention to provide a process and an apparatus for preparing hydrogen chloride that overcomes the above-mentioned disadvantages of the prior art methods and devices of this general type, which makes possible the virtually complete conversion of chlorine into hydrogen chloride without being tied to the availability of hydrogen.

With the foregoing and other objects in view there is provided, in accordance with the invention, a process for preparing hydrogen chloride. The process includes reacting feed gases, being chlorine with water vapor, in an endothermic reaction with heat being supplied in a first process step to give a mixture of hydrogen chloride and oxygen, and converting, in a second process step, the chlorine which has not been reacted in the first process step into hydrogen chloride in an exothermic reaction by adding a reducing agent and the oxygen formed in the first process step being bound by the reducing agent.

The object is achieved by the two-stage process of the invention for preparing hydrogen chloride from chlorine and steam or water using a reducing agent, preferably a gaseous hydrocarbon. A further object of the process of the invention is to avoid the presence of nitrogen in the combustion system in order to eliminate the above-mentioned disadvantages in the absorption of the hydrogen chloride and the after-combustion of the tailgas. In addition, the formation of chlorinated hydrocarbons and oxides of nitrogen should be prevented by the process of the invention. The process of the invention should also require a smaller amount of natural gas or other gaseous or vaporized hydrocarbons than the conventional process according to equation (2).

The object is achieved according to the invention by employing a two-stage process. In the first step of the process of the invention, chlorine reacts with water vapor while heat is being supplied to give a mixture of hydrogen chloride and oxygen, but without chlorine being reacted completely. In a second process step, the chlorine that has not reacted in the first process step is then reduced to hydrogen chloride in an exothermic reaction by addition of a reducing agent and the oxygen formed in the first process step is bound by the reducing agent. High-purity hydrochloric acid that is free of chlorine and CHCs can be produced from the hydrogen chloride obtained by the process of the invention in a known manner by absorption. However, the invention is not restricted to this use of the hydrogen chloride.

In accordance with an added mode of the invention, there is the step of carrying out the first process step at a temperature in a range of 350 to 1200° C. The second process step is carried out at a temperature in a range of 900 to 1600° C. The water vapor is superheated to 110 to 350° C. before it is fed in in the first process step. The water vapor is fed in in a 1.5-fold to 2.5-fold excess. The reducing agent is methane, natural gas, vaporizable hydrocarbons, carbon monoxide or hydrogen. The reducing agent together with the water vapor is fed in, with an amount of steam being set so that a temperature in a range of 900 to 1600° C. is established. In addition, the water vapor can be utilized as a driving medium for a jet pump for conveying reaction gases for the first and/or second process steps into a reactor. The feed gases used in the first process step are heated with heat liberated in the second process step.

In accordance with another mode of the invention, the endothermic reaction of the first process step is carried out in a presence of a catalyst being selected from heavy metal salts. The heavy metal salts are immobilized on a support made of heat-resistant ceramic. Copper(II) salt can be used as the catalyst.

An additional object of the invention is to provide an apparatus suitable for performing the process of the invention. In the apparatus, a reactor for carrying out a endothermic first process step is heatable and a reactor for carrying out the exothermic second process step is cooled, with at least one facility for introducing further materials being located between the two reactors.

In accordance with an additional feature of the invention, the first reactor functions as a cooler for the second process step and the second reactor functions as a heater for the first process step. The first and second reactors are disposed so that reaction gases of the first process step are conveyed in a countercurrent fashion to reaction gases of the second process step.

In accordance with a further feature of the invention, the first and second reactors are configured as concentrically disposed tubes, including an inner tube and an outer tube, with an annular space defined between the tubes. A first inlet for introducing the starting materials is disposed at a first end of the inner tube. The outer tube has a first closed end, a second open end, and a region projecting beyond a second open end of the inner tube. The region of the outer tube projecting beyond the second open end of the inner tube forms a combustion chamber. A second inlet for introducing the reducing agent is disposed adjoining the combustion chamber. An outlet is disposed at the second open end of the outer tube and outputs the hydrogen chloride.

In accordance with another further feature of the invention, the first and second reactors are configured as concentrically disposed tubes, including an inner tube and an outer tube, with an annular space defined between the tubes. A first inlet for introducing the starting materials is disposed at a first end of the outer tube. The outer tube has a second closed end disposed beyond a first open end of the inner tube. A region of the outer tube projecting beyond the first open end of the inner tube forms a combustion chamber. An inlet for introducing the reducing agent adjoins the combustion chamber. An outlet for outputting the hydrogen chloride is disposed at a second end of the inner tube.

In accordance with an added additional feature of the invention, the inner tube is one of a plurality of inner tubes disposed in the outer tube and defining reaction zones. In addition, internals are disposed between the inner tubes in the reaction zones and radiate heat absorbed from product gases to the inner tubes and the starting materials present therein. At least one of the reaction zones defined in the inner tubes and the reaction zones defined in the outer tube contains packing that forms an open-pored system.

Alternatively, static mixers are disposed in at least one of the reaction zones defined in the inner tubes and the reaction zones defined in the outer tube.

In accordance with a concomitant feature of the invention, the second reactor for the second process step is a pore burner.

Other features which are considered as characteristic for the invention are set forth in the appended claims.

Although the invention is illustrated and described herein as embodied in a process and an apparatus for preparing hydrogen chloride, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a basic structure of an apparatus for preparing hydrogen chloride by a process according to the invention; and

FIGS. 2 and 3 are diagrammatic, sectional views showing advantageous embodiments of the apparatus for preparing hydrogen chloride by the process of the invention.

### DESCRIPTION OF THE PREFERRED EMBODIMENTS

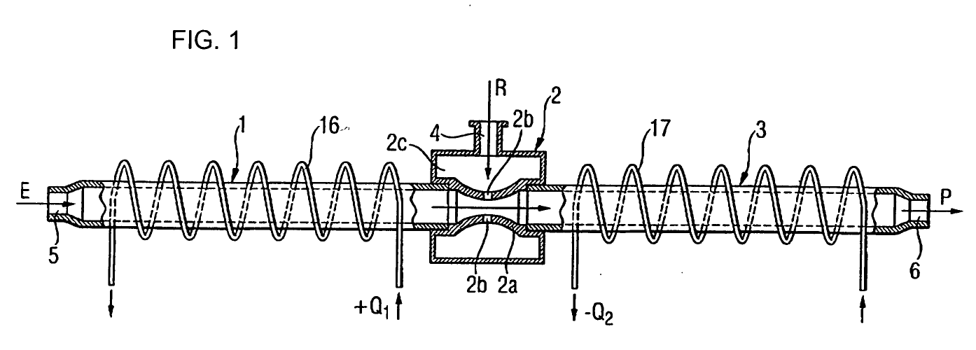

Referring now to the figures of the drawing in detail and first, particularly, to FIG. 1 thereof, there is shown the first step of a process of the invention that corresponds to the reversal of the Deacon process for obtaining chlorine, in accordance with equation (3*):

Cl₂+H₂O→2HCl+0.5O₂ ΔH_{R}=+57.42 kJ (3)

The reaction according to equation (3) is endothermic in the direction of the formation of hydrogen chloride and oxygen. Therefore heat has to be supplied to the reaction system in order to obtain hydrogen chloride. Furthermore, thermal dissociation of hydrogen chloride into the elements is promoted with increasing temperature:

2HCl→H₂+Cl₂ (7)

It has been determined by thermodynamic calculations that the yield of hydrogen chloride in the system described by the equations (3) and (7) reaches a maximum at 1200° C. The theoretical yield of hydrogen chloride at this temperature is about 95%. At 750° C., a theoretical yield of hydrogen chloride of about 80% is obtained.

In the process of the invention, the reaction according to equation (3) is carried out at a temperature in the range from 350 to 1200° C. The water vapor is advantageously added in a superheated state, particularly advantageously at a temperature of 110-350° C., to achieve heating of the chlorine and to prevent formation of condensate. Chlorine is also advantageously preheated to from 100 to 120° C. Water vapor is preferably fed into the reaction system in a 1.5-fold to 2.5-fold excess in order to favor the reaction in the desired direction of the formation of hydrogen chloride. Particularly intensive mixing of the starting materials is achieved when the water vapor functions as driving medium for a jet pump which conveys the feed gases into the reactor.

A gas mixture produced according to equation (3) is, for example, still unsuitable for obtaining a high-purity hydrochloric acid because of the residual chlorine present, since the reaction of the chlorine according to equation (3) does not proceed to completion. In addition, the equilibrium is shifted back in favor of chlorine formation on cooling.

For these reasons, the endothermic first stage of the process of the invention is followed by an exothermic second process stage. In the second stage, chlorine that has not yet reacted in the first process step is reduced to hydrogen chloride by the addition of a gaseous or vaporized reducing agent and the oxygen formed in the first process step is bound by the reducing agent. The process is strongly exothermic. Suitable reducing agents are, for example, methane, natural gas, carbon monoxide (CO), hydrogen, vaporizable hydrocarbons or mixtures thereof. Reducing combustion gases that are rich in hydrogen and carbon monoxide, as are obtained from reducing burners, i.e. burners operated with a deficiency of oxygen, are also suitable.

When methane is used as the reducing agent, it is virtually completely oxidized to carbon dioxide and the following reaction occurs in the second process step:

2Cl₂+CH₄+O₂→4HCl+CO₂ (8)

In the process of the present invention, this reaction is carried out at temperatures in the range from 900 to 1600° C. The reducing agent for the second process step is advantageously fed in together with water vapor. Taking into account the amount of steam added in the first step, steam is added in the second step together with the reducing agent in the amount necessary to bring the temperature into the advantageous range from 900 to 1600° C. The cooling effect of the water vapor alters the temperature for the second reaction stage in the direction favorable for the formation of hydrogen chloride. However, the introduction of water vapor has to be controlled so that the temperature of the reactor does not drop below 900° C. At lower temperatures, there is the risk of forming chlorinated hydrocarbons.

Feeding in the reducing agent together with water vapor improves the mixing of the reactants, particularly when the reducing agent and water vapor are conveyed into the reactor by a steam-operated jet pump.

Combining the equations (3) and (8) gives the following net equation for the overall process:

4Cl₂+CH₄+2H₂O→8HCl+CO₂ (9)

The excess of methane shifts the equilibrium of equation (9) in favor of the formation of hydrogen chloride. In an advantageous variant of the process of the invention, the reducing agent is therefore metered in so that the ratio of the molar amount of reducing agent fed in to the initial molar amount of chlorine is from 1:4 to 1.5:4. The higher the excess of reducing agent, the higher the proportion of carbon monoxide in the product gas, since the excess reducing agent can no longer be oxidized completely to carbon dioxide. Carbon monoxide is not soluble in hydrochloric acid and is disposed of by thermal after-combustion of the product gas after absorption of the hydrogen chloride.

In downstream steam generators or gas coolers and absorbers, the product gas is processed further to hydrochloric acid, advantageously with recovery of heat.

It can be seen from the energy changes in the two reactions that the exothermic second process step liberates sufficient energy for the endothermic first process step to be advantageously supported by heat from the second process step being supplied to the chlorine/steam mixture. This can be achieved particularly advantageously by conveying the reactants of the first process step in countercurrent to those of the second process step.

It is also advantageous to accelerate the first reaction of the process of the invention by catalysts. Catalysts that can be used for this purpose are those which are effective in chlorine formation by the Deacon reaction according to equation (3*).

Further details and embodiments of the apparatus for carrying out the process of the invention are described below. The basic structure of this apparatus is shown schematically in FIG. 1.

The apparatus contains a first reactor which is formed, for example, by a tube 1 and has a heating device 16 and in which a feed mixture E of chlorine and water vapor introduced via an inlet 5 is reacted in an endothermic reaction according to equation (3) in the first process step, and a downstream second reactor which is formed, for example, by a tube 3 and has a cooling device 17 and in which the exothermic reaction of the second process step proceeds according to equation (8) and from which a product mixture P can be taken off via the outlet 6. The tubes 1 and 3 of the reactors are connected by a connecting piece 2 via which a reducing agent R, for example methane, required for the second process step can be fed in. The connecting piece 2 is advantageously configured as a Venturi nozzle 2a at whose constriction the reducing agent R is drawn in through one or more holes 2b. The Venturi nozzle 2a is surrounded by a distributor chamber 2c that has an inlet 4 for the reducing agent R.

The product gas mixture P has been largely cooled when it leaves the reactor 3 via an opening 6 and is passed to a non-illustrated absorber for further processing.

In an advantageous embodiment of the apparatus, the heat evolved in the second process step is utilized at least partly for heating the starting materials E, for example by a heat exchanger or by conveying the reaction gases of the first process step in countercurrent to those of the second process step.

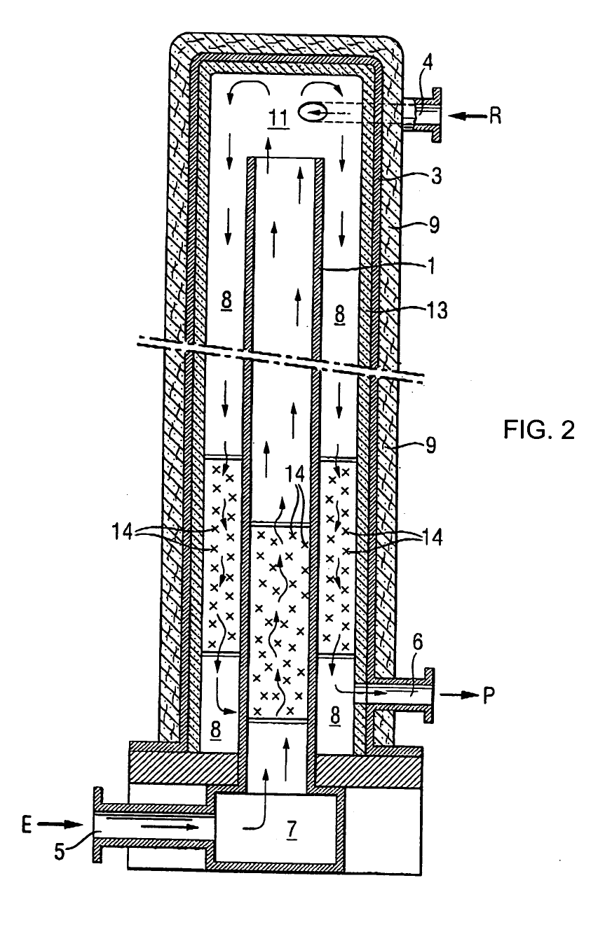

FIG. 2 shows an apparatus that makes it possible to exploit the heat liberated in the exothermic second process step for heating the starting materials E for the endothermic first process step. The reactor contains two concentrically disposed tubes 1 and 3. At one end of the inner tube 1, there is a feed chamber 7 with the inlet 5 for the starting materials E. The outer tube 3 projects beyond the other open end of the inner tube 1 and is closed at this end. The region of the outer tube 3 projecting beyond the open end of tube 1 will hereinafter be referred to as a combustion chamber 11. The preheated and partly reacted starting materials E flow from the open end of the inner tube 1 into the combustion chamber 11 into which the reducing agent R for the exothermic second process step is fed via the inlet 4. The inlet 4 for the reducing agent R is preferably disposed tangentially on tube 3.

The internal diameter of the tube 3 is such that an annular space serving as a reaction zone 8 is formed between the inner tube 1 and the outer tube 3. After addition of the reducing agent R, the reaction mixture flows through the reaction zone 8 in countercurrent to the stream E of chlorine and water vapor in tube 1 which is to be heated and heats the latter to the required reaction temperature by the heat liberated in the exothermic reaction. The cooled product gas mixture P leaves the reactor at the outlet 6 at the end of the tube 3 opposite the closed end.

In a particularly advantageous variant of this apparatus, static mixing elements 14 are provided in the reaction zones in the inner tube 1 and/or in the reaction zone 8 in the outer tube 3 to improve mixing and heat transfer.

The apparatuses depicted in FIGS. 1 and 2 can be started up in a particularly simple fashion by, for example, blowing in a mixture of fuel and air at the inlet 4 at which the reducing agent R is added during operation of the process and igniting it. After the apparatus has been preheated sufficiently, introduction of chlorine and water vapor is commenced. The flow of combustion air introduced via the inlet 4 is decreased correspondingly until the above-described, desired reaction proceeds.

In an alternative embodiment of this apparatus according to the invention, the flow direction is reversed so that the endothermic first process step occurs in the annular space 8 between the inner tube 1 and the outer tube 3 and the exothermic second process step occurs in the inner tube 1. In this variant, the starting materials are fed in via the opening into the outer tube 3 and the products are taken off from the inner tube 1 via an opening.

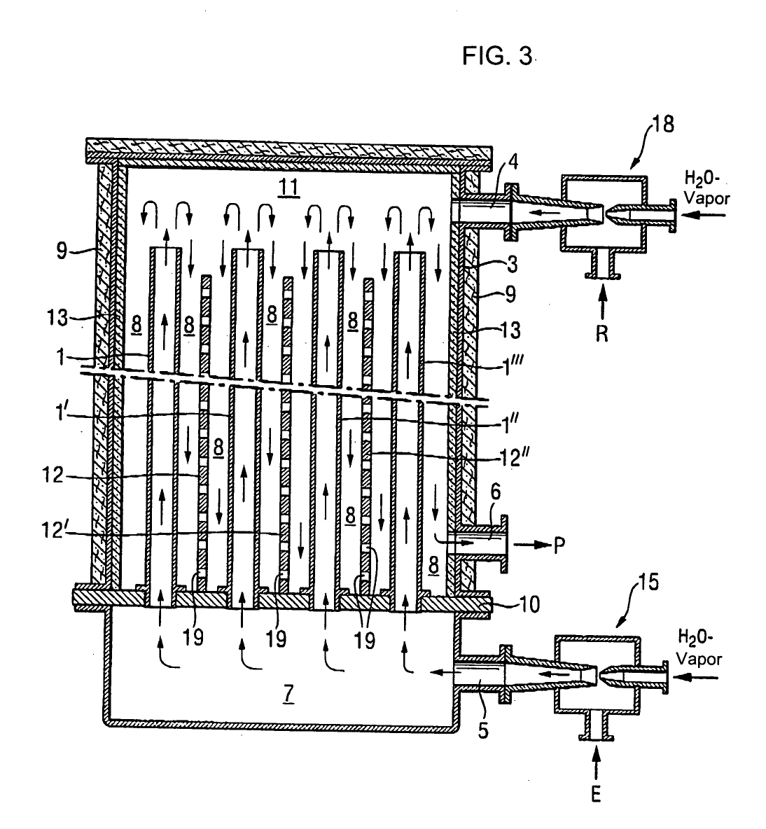

One advantageous embodiment of the apparatus of FIG. 2 is shown in FIG. 3. In this embodiment, the outer tube 3 contains at least two inner tubes 1, 1′, 1″ . . . . The open ends of the tubes 1, 1′, 1″ . . . open into the combustion chamber 11 which is bounded by the closed end of the outer tube 3. The starting materials E are, for example, conveyed by a steam-operated jet pump 15 with intensive mixing into the feed chamber 7 which is separated from the reaction zone 8 by a tube plate 10. From the feed chamber 7, the starting materials E flow into the inner tubes 1, 1′, 1″ . . . , are heated and react according to equation (3). The stream containing products and unreacted starting materials E which leaves the tubes 1, 1′, 1″ . . . is reacted with the reducing agent R in an exothermic reaction in the combustion chamber 11. The reducing agent R is advantageously also fed in by a steam-operated jet pump 18. The hot products P flow through the preferably elongated reaction zone 8 enclosed by the outer tube 3 in countercurrent to the starting materials E in the tubes 1, 1′, 1″ . . . , heat the starting materials and leave the apparatus via the outlet 6.

In an advantageous variant of the apparatus, the static mixing elements 14 are provided in the reaction zones in the inner tubes 1, 1′, 1″ . . . and/or in the reaction zone 8 in the outer tube 3 to improve mixing and heat transfer. The static mixing elements 14 are not shown in FIG. 3 in the interest of clarity. They are disposed in a manner corresponding to that depicted in FIG. 2.

Heat transfer between the reaction zones can be improved further by installing porous internals, for example walls 12, 12′, 12″ . . . , in the reaction zone 8 between the tubes 1, 1′, 1″ . . . . The walls 12, 12′, 12″ . . . are heated by the product gases P and radiate heat to the tubes 1, 1′, 1″ . . . and have openings 19 through which the product gases P can flow to the outlet 6.

Suitable materials for the tubes 1, 1′ 1″ . . . through which the feed mixture E to be heated flows are ceramics which have both a high heat resistance and high corrosion resistance, for example silicon carbide, silicon nitride and oxide ceramics.

The heat-radiating walls 12, 12′, 12″ . . . in the reaction zone 8 are preferably likewise made of a ceramic material, for example aluminum oxide or silicon carbide.

Heat transfer and mass transfer are improved when the tubes 1, 1′, 1″ . . . and/or tube 3 are completely or at least partly filled with a bed of inert packing. Suitable packing elements are, inter alia, Raschig rings, spheres, crushed material, saddles or foams composed of carbide, silicate or oxide ceramics. The packing elements form an open-pored system which acts as or forms the static mixer 14 (see FIG. 2).

As an alternative, the reactor for the exothermic second process step can be configured as a pore burner. The construction and mode of operation of pore burners are described, for example, in German Patent DE 199 39 951.

In a further embodiment of the apparatus, a catalyst that has been applied to a heat-resistant and corrosion-resistant, inert support is provided in the tubes in which the reverse Deacon reaction takes place in order to accelerate the reaction. The catalyst can also be applied to structures of the above-described type configured as static mixers or to ceramic honeycombs. As suitable catalysts for the Deacon reaction according to equation (3*), the literature discloses salts of the following metals: K, Be, Mg, Sc, Y, lanthanides, Ti, Zr, Cr, Mo, W, Mn, Fe, Co, Ni, Cu, Au, Zn, Pb, Sb, Bi, Pt, Th, U/F. See the reference by Wolf et al., titled “Zeitschrift für anorganische und allgemeine Chemie”, Vol. 304 (1960), pages 48 to 57/, and also oxides of copper and manganese (manganese dioxide)/M. W. Hisham and S. W. Benson, J. Phys Chem. Vol 989 (1995), pages 6194-6198.

Suitable support materials for the catalyst are ceramic materials based on carbides, for example silicon carbide, based on silicates, for example fired clay, or based on oxides, for example aluminum oxide. The choice of support material depends on the temperature at which the catalyst is to be used.

Catalyst supports, e.g. supports based on silicon carbide, produced by slip casting can likewise be used. Here, the catalyst can be firmly bound into the support structure by a slip.

The tube 3 with the combustion chamber 11 is made of graphite or steel. A graphite reactor has to be externally cooled by water. However, cooling of the gases flowing in the vicinity of the reactor wall should be avoided if at all possible.

This would produce a non-uniform temperature distribution in the reactor with a temperature gradient from the interior of the reactor to the region close to the wall. The inside of the wall of the graphite reactor is therefore provided with a masonry lining 13 or an insert made of a ceramic material.

If the reactor is made of steel, cooling to below the dew point of the product gases has to be avoided since the hydrochloric acid formed in such a case would lead to corrosion of the reactor. For this reason, a steel reactor contains the masonry lining 13 and/or an outer layer of thermal insulation 9, for example mats of ceramic fiber material, to reduce heat loss. The corrosion resistance can also be improved by enameling the steel reactor.

This application claims the priority, under 35 U.S.C. § 119, of German patent application No. 103 09 799.6, filed Mar. 5, 2003; the entire disclosure of the prior application is herewith incorporated by reference.

We claim:

1. A process for preparing hydrogen chloride, which comprises the steps of:
reacting feed gases, being chlorine with water vapor, in an endothermic reaction with heat being supplied in a first process step to give a mixture of hydrogen chloride and oxygen; and
converting, in a second process step, the chlorine which has not been reacted in the first process step into hydrogen chloride in an exothermic reaction by adding a reducing agent and the oxygen formed in the first process step being bound by the reducing agent.

2. The process according to claim 1, which further comprises carrying out the first process step at a temperature in a range of 350 to 1200° C.

3. The process according to claim 1, which further comprises carrying out the second process step at a temperature in a range of 900 to 1600° C.

4. The process according to claim 1, which further comprises superheating the water vapor to 110 to 350° C. before it is fed in in the first process step.

5. The process according to claim 1, which further comprises introducing the water vapor fed in in a 1.5-fold to 2.5-fold excess.

6. The process according to claim 1, which further comprises selecting the reducing agent from the group consisting of methane, natural gas, vaporizable hydrocarbons, carbon monoxide and hydrogen.

7. The process according to claim 1, which further comprises feeding in the reducing agent together with the water vapor, with an amount of steam being set so that a temperature in a range of 900 to 1600° C. is established.

8. The process according to claim 1, which further comprises utilizing the water vapor as a driving medium for a jet pump for conveying reaction gases for at least one of the first and second process steps into a reactor.

9. The process according to claim 1, which further comprises heating the feed gases used in the first process step with heat liberated in the second process step.

10. The process according to claim 1, which further comprises carrying out the endothermic reaction of the first process step in a presence of a catalyst selected from the group consisting of heavy metal salts.

11. The process according to claim 10, which further comprises immobilizing the heavy metal salts on a support made of heat-resistant ceramic.

12. The process according to claim 10, which further comprises selecting copper(II) salt as the catalyst.

13. An apparatus for preparing hydrogen chloride, comprising:
a first reactor having heating for reacting chlorine with water vapor being starting materials in an endothermic reaction with heat being supplied in a first process step to give a mixture of hydrogen chloride and oxygen;
a second reactor having cooling for converting, in a second process step, the chlorine which was not reacted in the first process step into hydrogen chloride in an exothermic reaction by adding a reducing agent and the oxygen formed in the first process step being bound by the reducing agent, said first reactor being connected to said second reactor; and
at least one facility for introducing the reducing agent being disposed in a region of connection between said first and second reactors.

14. The apparatus according to claim 12, wherein said first reactor functions as a cooler for the second process step and said second reactor functions as a heater for the first process step.

15. The apparatus according to claim 13, wherein said first and second reactors are disposed so that reaction gases of the first process step are conveyed in a countercurrent fashion to reaction gases of the second process step.

16. The apparatus according to claim 13,
wherein said first and second reactors are configured as concentrically disposed tubes, including an inner tube and an outer tube, with an annular space defined between said tubes;
further comprising a first inlet for introducing the starting materials and disposed at a first end of said inner tube, said outer tube having a first closed end, a second open end, and a region projecting beyond a second open end of said inner tube,
said region of said outer tube projecting beyond said second open end of said inner tube forming a combustion chamber;
further comprising a second inlet for introducing the reducing agent and disposed adjoining said combustion chamber; and
further comprising an outlet disposed at said second open end of said outer tube and outputting the hydrogen chloride.

17. The apparatus according to claim 13,
wherein said first and second reactors are configured as concentrically disposed tubes, including an inner tube and an outer tube, with an annular space defined between said tubes;
further comprising a first inlet for introducing the starting materials and disposed at a first end of said outer tube;
wherein said outer tube has a second closed end disposed beyond a first open end of said inner tube;
wherein a region of said outer tube projecting beyond said first open end of said inner tube forms a combustion chamber;
further comprising an inlet for introducing the reducing agent and adjoining said combustion chamber; and
further comprising an outlet for outputting the hydrogen chloride and disposed at a second end of said inner tube.

18. The apparatus according to claim 16, wherein said inner tube is one of a plurality of inner tubes disposed in said outer tube and defining reaction zones.

19. The apparatus according to claim 18, further comprising internals disposed between said inner tubes in said reaction zones and radiate heat absorbed from product gases to said inner tubes and the starting materials present therein.

20. The apparatus according to claim 18, wherein at least one of said reaction zones defined in said inner tubes and said reaction zones defined in said outer tube contains packing which forms an open-pored system.

21. The apparatus according to claim 19, further comprising static mixers disposed in at least one of said reaction zones defined in said inner tubes and said reaction zones defined in said outer tube.

22. The apparatus according to claim 13, further comprising a catalyst, immobilized on a support made of heat-resistant ceramic, is disposed in said first reactor in which the first process step occurs.

23. The apparatus according to claim 22, wherein said catalyst contains a copper(II) salt.

24. The apparatus according to claim 22, wherein said catalyst is immobilized on said support made of said ceramic material selected from the group consisting of carbides, oxides and silicates.

25. The apparatus according to claim 24, wherein said catalyst is immobilized on a support made of aluminum oxide ceramic.

26. The apparatus according to claim 13, wherein said second reactor for the second process step is a pore burner.
